(19) United States
(12) Patent Application Publication
(10) Pub. No.: US 2016/0288150 A1
(43) Pub. Date: Oct. 6, 2016

(54) DRIP TAPE INSTALLATION TOOL

(71) Applicants: Allisa Jungha Song, Seattle, WA (US); Elias Lee Baker, Seattle, WA (US); Adam Bigelow, Auburn, WA (US); Christopher DiTomaso, Seattle, WA (US); Olga Vitruk, Seattle, WA (US)

(72) Inventors: Allisa Jungha Song, Seattle, WA (US); Elias Lee Baker, Seattle, WA (US); Adam Bigelow, Auburn, WA (US); Christopher DiTomaso, Seattle, WA (US); Olga Vitruk, Seattle, WA (US)

(21) Appl. No.: 15/089,343

(22) Filed: Apr. 1, 2016

Related U.S. Application Data
(60) Provisional application No. 62/142,261, filed on Apr. 2, 2015.
(60) Provisional application No. 62/301,641, filed on Mar. 1, 2016.

(51) Int. Cl. B05B 15/06; A01G 25/02

(52) U.S. Cl. CPC B05B 15/06; A01G 25/02

(57) ABSTRACT

An apparatus for installing irrigation drip tape, comprising a wheeled frame, a reel mounted on the wheeled frame and configured to hold a roll of irrigation drip tape, the roll of irrigation drip tape able to rotate freely on the reel, a stake driver, the stake driver configured to drive an agricultural stake into a soil, a activation control, the activation control configured to cause the stake driver to drive the agricultural stake into the soil, and a drip tape guide mounted on the wheeled frame, the drip tape guide configured to position irrigation drip tape dispensed from the reel under the stake driver such that the agricultural stake holds the irrigation drip tape in position when driven into the soil responsive to the activation control.

### CROSS REFERENCE TO RELATED APPLICATIONS

This application claims the benefit under 35 U.S.C. §119 of U.S. Provisional Application No. 62/142,261, filed Apr. 2, 2015, and U.S. Provisional Application No. 62/301,641, filed Mar. 1, 2016. The aforementioned provisional applications are hereby incorporated by reference in their entirety for any purpose.

### TECHNICAL FIELD

Examples described herein relate generally to agricultural irrigation. Examples of methods and apparatus for installing agricultural drip irrigation systems are described.

### BACKGROUND

Water scarcity is a global concern and nearly a third of the water supply in the United States is diverted to the irrigation of agricultural crops and other types of irrigation, including lawn and landscaping irrigation. There are various methods of irrigating, generally divided into four types: surface (such as flood irrigation), sprinkler, drip/trickle, and subsurface (delivering water underground to the roots of the crop).

Of these types of irrigation, drip irrigation is the most water efficient. Drip irrigation is accomplished by routing lines of irrigation “drip tape” on the surface of the soil in between the rows of crop in a field. Drip tape is typically a thin-walled, flexible PVC tube with holes, or emitters, along its surface. Water is routed into the runs of drip tape from a common header pipe, causing water to be delivered to the plants through the emitters.

By delivering the appropriate amount of water and nutrients directly to the roots of a crop from the emitters, drip irrigation is very efficient. It typically has a water efficiency of 90% or higher (compared to 60% efficiency for sprinkler systems, for example). This difference in efficiency accounts for six trillion gallons of water being wasted in the US annually.

Despite being the most water efficient, drip irrigation systems have the lowest adoption rate at 9%. A primary factor deterring the adoption of drip irrigation is the time and labor that goes into installing and securing the drip tape.

Drip irrigation is a versatile irrigation system used on a variety of plot sizes from small flower gardens to massive industrial production. On the small garden scale, drip tape can be installed reasonably by hand with minimal effort. On the other side of the spectrum, industrial farms install thousands of feet of drip tape at a time using massive tractor attachments with multiple workers riding along and managing the tape reels. However, mid-sized fields in between these extremes, there are no practical options for installing drip tape.

### SUMMARY

In one aspect, the invention is an apparatus for installing irrigation drip tape, comprising a wheeled frame, a reel mounted on the wheeled frame and configured to hold a roll of irrigation drip tape, a stake driver configured to drive a stake into the ground, an activation control configured to cause the stake driver to drive the stake into the ground, and a drip tape guide mounted on the wheeled frame, configured to position a length of drip tape dispensed from the reel under the stake driver such that the stake holds the drip tape in position when driven into the soil responsive to the activation control.

In another aspect, the invention is an apparatus for placement of an agricultural material such as landscaping fabric or irrigation drip tape in soil, the apparatus comprising a linear actuator, a plunger attached to the linear actuator, a stake chute to guide movement of the stake in a direction and at an orientation, a drive system providing energy to the linear actuator to extend and retract to drive the stake into the ground; and an activation control configured to cause the linear actuator to drive the stake into the ground.

In yet another aspect, the invention is a method for installing irrigation drip tape, the method comprising the steps of feeding a length of irrigation drip tape into a drip tape guide configured to lay the irrigation drip tape at a position and at an orientation onto an area of the ground, orienting a stake driver configured to drive stakes into the ground such that the stakes are placed to hold the drip tape at the position and at the orientation on the ground, supplying one or more stakes to the stake driver, and actuating the stake driver to drive the stakes into the ground at desired intervals.

Other aspects, features, objects, and advantages of the invention will become apparent to those skilled in the art from the following detailed description and accompanying drawings. It should be understood, however, that the detailed description and specific examples are given by way of illustration and not of limitation. Many changes and modifications may be made within the scope of the present invention without departing from the spirit thereof, and the invention includes all such modifications.

### BRIEF DESCRIPTION

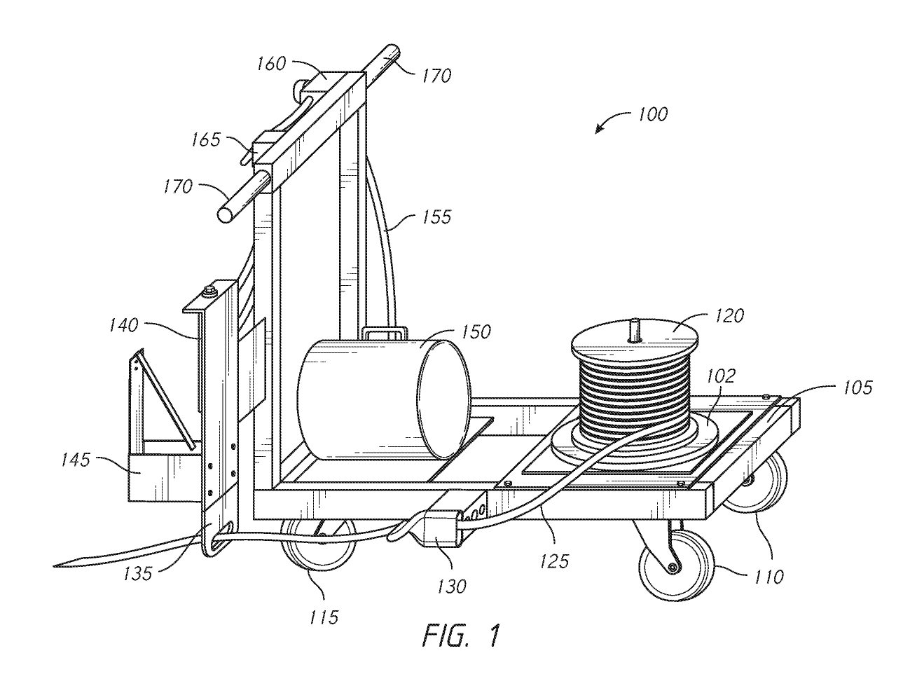

FIG. 1 is a perspective view of a drip tape installation tool arranged in accordance with examples described herein.

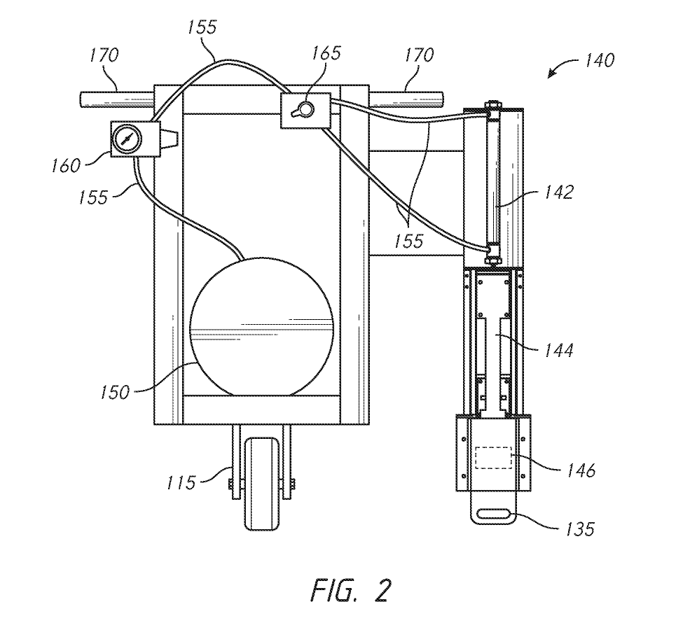

FIG. 2 is a rear view of the drip tape installation tool of FIG. 1, showing additional detail on some components arranged in accordance with examples described herein.

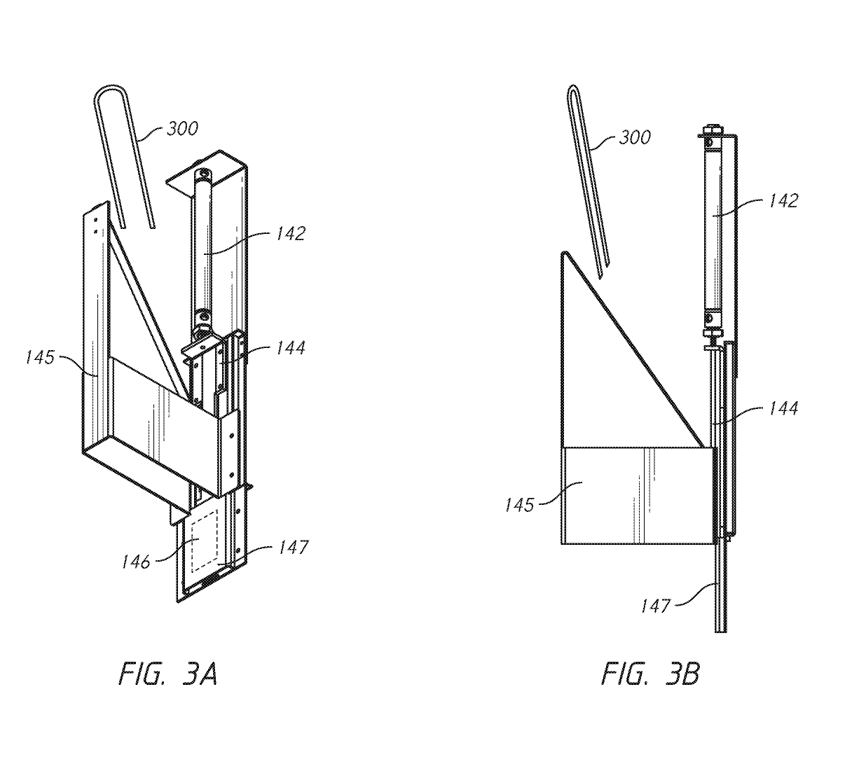

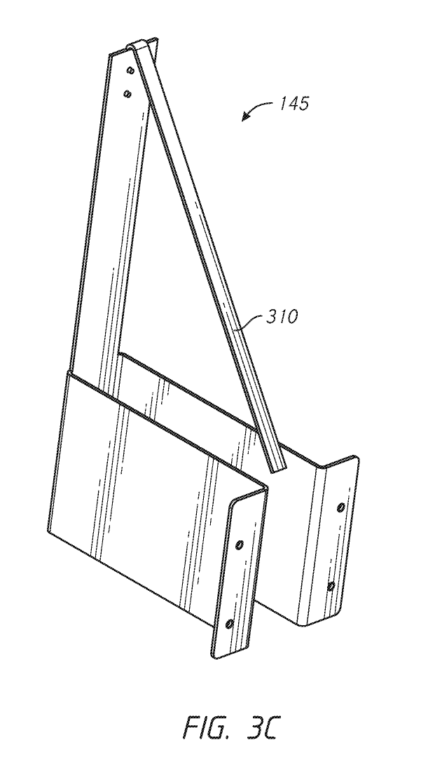

FIG. 3A is a perspective view of the stake driver of the drip tape installation tool of FIG. 1 arranged in accordance with examples described herein.

FIG. 3B is a side view of the stake driver of FIG. 3A arranged in accordance with examples described herein.

FIG. 3C is a perspective view of the stake glide component of the stake driver of FIG. 3A arranged in accordance with examples described herein.

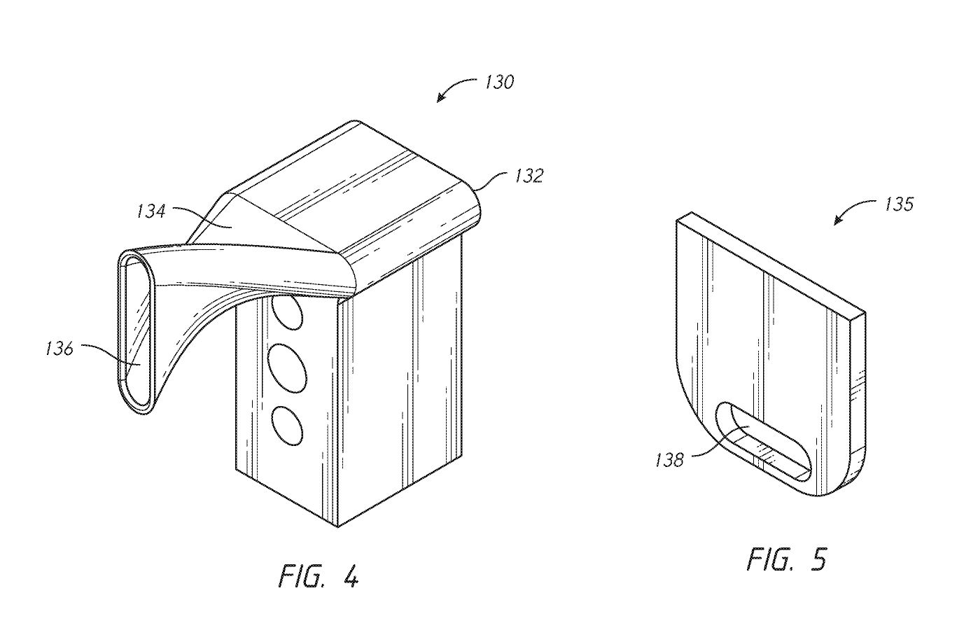

FIG. 4 is a perspective view of one embodiment of a first drip tape guide for use on the drip tape installation tool of FIG. 1 arranged in accordance with examples described herein.

FIG. 5 is a perspective view of one embodiment of a second drip tape guide for use on the drip tape installation tool of FIG. 1 arranged in accordance with examples described herein.

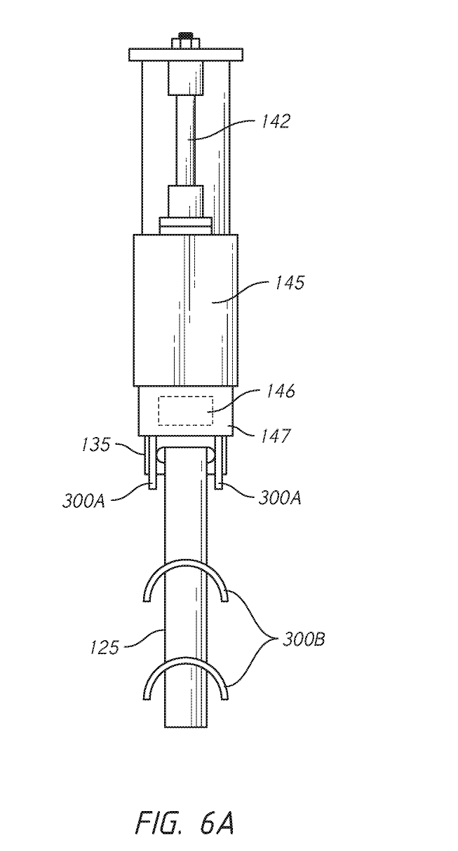

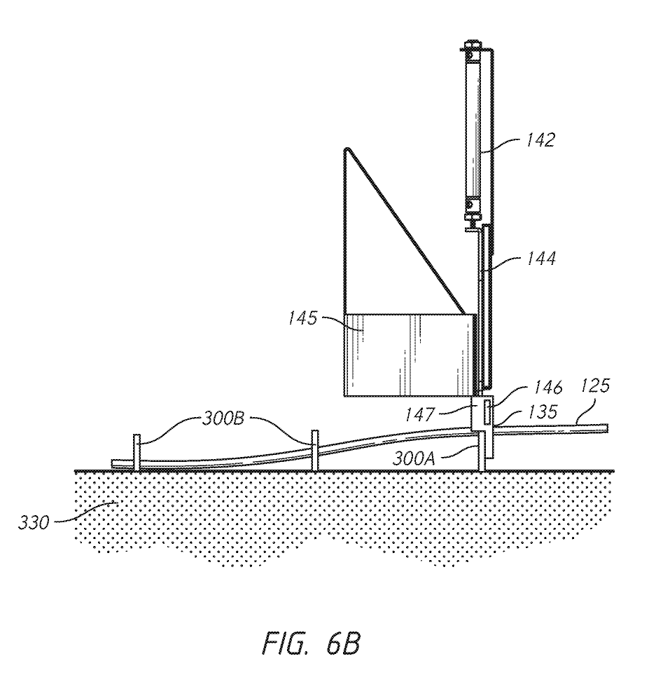

FIG. 6A shows a rear view of the stake driver of FIG. 3A as it is used in staking irrigation drip tape arranged in accordance with examples described herein.

FIG. 6B shows a side view of the stake driver of FIG. 3A as it is used in staking irrigation drip tape arranged in accordance with examples described herein.

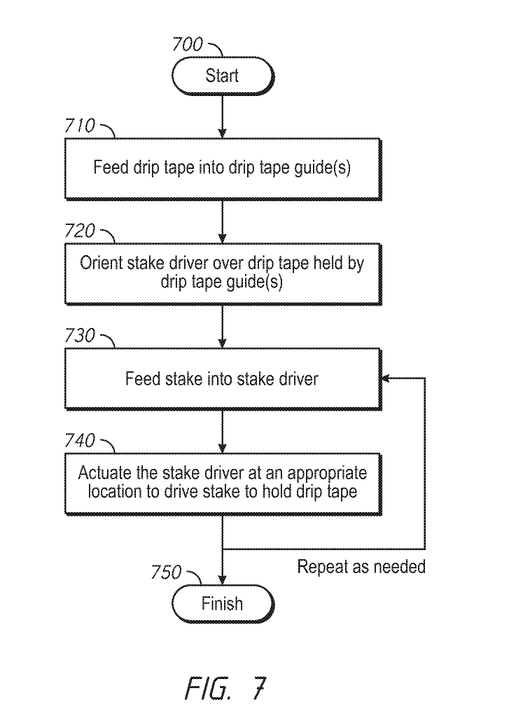

FIG. 7 is a flowchart detailing the steps of a method for installing irrigation drip tape arranged in accordance with examples described herein.

### DETAILED DESCRIPTION

Certain details are set forth below to provide a sufficient understanding of embodiments of the invention. However, it will be clear to one skilled in the art that embodiments of the invention may be practiced without various of these particular details. In some instances, well-known devices, components, and user controls have not been shown in detail in order to avoid unnecessarily obscuring the described embodiments of the invention.

Various embodiments will be described more fully hereinafter with reference to the accompanying drawings. In explanations of the various embodiments, the same or corresponding elements may be denoted by the same reference designators. For the sake of brevity and to avoid duplicate explanation, descriptions to the same elements as set forth in one embodiment may be omitted or only briefly mentioned in each succeeding embodiment.

As used herein, the term “drip tape” shall be defined to refer to any of a number of flexible conduit-type materials used for channeling water and/or other liquids for irrigation purposes, including but not limited to drip tape, drip tubing, drip line, micro tubing, PC drip line, hose, and drip hose, or any other appropriate flexible conduit-type material. For the purposes of this specification, these terms shall be considered to be synonymous with each other and shall be used interchangeably.

As used herein, the terms “agriculture” or “agricultural” shall be defined to refer to any industry related to living plants, including but not limited to farming, forestry, orchard maintenance, lawn care, and home and commercial landscaping. For the purposes of this specification, these terms shall be considered to be synonymous with each other and shall be used interchangeably.

FIG. 1 is a perspective view of an example drip tape installation tool. In some examples, a drip tape installation tool 100 includes a cart frame 105 with two fixed front wheels 110 and a single rear swivel wheel 115 for maneuvering the drip tape installation tool 100 through a field. Although the embodiment shown in FIG. 1 shows two fixed front wheels 110 and a single rear swivel wheel 115, other configurations, quantities, and types of wheels could be used on the cart frame 105 without deviating from the inventive concept herein. For example, using two swivel wheels 115 on the rear of the cart with a spacing approximately equal to the spacing of the two front wheels 110 may more easily allow the drip tape installation tool 100 to be pushed through an emerging crop, as the separated rear wheels may be placed on either side of a row of plants without crushing them. One or more handles 170 may be provided on the cart frame 105 to allow an operator to direct the drip tape installation tool 100 through a field during installation.

A drip tape reel 102 is mounted on the cart frame 105 such that the drip tape reel 102 is allowed to rotate freely. A drip tape roll 120 containing drip tape 125 is placed onto the drip tape reel 102. In operation, the drip tape 125 is pulled off of the rotating drip tape roll 120 and fed into one or more drip tape guides (130, 135) to properly position it for installation on the surface of the ground beneath the drip tape installation tool 100.

In the embodiment shown in FIG. 1, the axis of rotation of the drip tape reel 102 is approximately perpendicular to the bottom, horizontal plane of the cart frame 105. Although the drip tape 125 is a tube used as a conduit for the delivery of water, it is typically manufactured and stored on a drip tape roll 120 in a flattened form. Ideally, the drip tape 125 will be installed in a field with no twists or buckles with one of its flattened surfaces in direct contact with the soil. When the drip tape 125 is pulled from the drip tape reel 102 with the orientation shown in FIG. 1, the drip tape 125 is fed into a first drip tape guide 130, which comprises a twisted channel that turns the drip tape 125 as it passes through to ensure an orientation appropriate for installation (that is, with a flat side facing down.) In some examples, the degree of rotation of the drip tape 125 as it passes through the first drip tape guide 130 may be approximately 90 degrees.

After exiting the first drip tape guide 130, the drip tape 125 may be fed into a second drip tape guide 135. The second trip tape guide 135 may be used to position the drip tape such that it is centered beneath a stake driver 140. After exiting the second drip tape guide 135, the drip tape 125 is placed in contact with the soil. As the drip tape installation tool 100 is pushed in a forward direction during operation (that is, in a direction such that the fixed front wheels 110 are leading), the drip tape 125 is pulled from the drip tape roll 120 and through the drip tape guides (130, 135) and placed flat on the soil beneath the cart.

In some examples, the drip tape reel 102 may be mounted such that its axis of rotation is horizontal instead of vertical, allowing the drip tape 125 to come off of the drip tape roll 120 already in a flattened orientation appropriate for direct placement on the soil. In some examples, the first drip tape guide 130 may have a different design, or may not be required at all. In some examples, any appropriate number and design of drip tape guides may be used to route and orient the drip tape 125 for placement on the soil.

Once the drip tape 125 is placed in its proper orientation and position in the soil, a staple or stake may be driven on top of or near the drip tape 125 to hold it in place in the soil. In the embodiment shown in FIG. 1, an automatic stake driver 140 may be used to drive the stake into the soil. An operator may place a stake, such as a landscaping or garden staple or similar, into the stake guide 145. The stake is fed into the bottom of the stake driver 140, held in place over the drip tape 125, and then driven into the ground by the action of the stake driver 140, straddling and anchoring the drip tape 125 in the soil.

In some examples, the stake driver 140 may be driven by a pneumatic drive. A compressed air tank 150 is mounted on the cart frame 105. Pneumatic tubes 155 route the compressed air from the compressed air tank 150 do a pressure regulator 160. The operator may use the pressure regulator 160 to control the pressure of the compressed air to control the power with which the stakes are driven into the soil. After the pressure regulator 160, the regulated compressed air may be passed to an activation control 165, such as a solenoid switch, which allows the compressed air to be driven to the appropriate portion of the stake driver 140 to drive the stake into the soil. In this example, the pressure regulator 160 and the activation control 165 represent the user interface for a human operator for the irrigation drip tape installation tool. In other examples, the user interface may include other types of user controls, including pushbuttons, levers, rotary knobs, displays, numeric readouts, and any other appropriate type of user control.

Although a pneumatic drive is shown in FIG. 1, any appropriate type of drive may be used, including but not limited to an electric drive, hydraulic drive, and human power.

FIG. 2 is a rear view of the drip tape installation tool of FIG. 1, showing additional detail on some components, and in particular the stake driver system. Some components on the drip tape installation tool not directly related to the stake driver system have been omitted in FIG. 2 for clarity.

Referring to FIG. 2, in some examples, the stake driver 140 may comprise a linear actuator 142, a plunger 144, a stake chute 147, and a staple retention mechanism 146. The linear actuator may also optionally comprise a drip tape guide 135 for holding the drip tape (FIG. 1, 125) in position beneath the stake driver 140.

The linear actuator 142 is powered by a drive system. In some examples, the drive system may be compressed air. Pneumatic tubes 155 deliver air to either end of the linear actuator 142, and the compressed air is used to extend the linear actuator (extend it down toward the soil) when delivered to one end of the linear actuator 142 and retract it when delivered to the other end of the linear actuator 142. The function of a linear actuator is well known to a person of ordinary skill in the art, and so additional detail on the functioning has been omitted for brevity.

When extended, the linear actuator 142 presses down on a plunger 144. In some examples, the plunger 144 is a thin, rigid component designed to slide through the stake chute 147 and drive a stake into the soil to hold a length of drip tape in place.

Before the linear actuator 142 is extended, a stake may be inserted by an operator. The stake is placed into a stake guide which will guide the stake into position inside the stake chute 147, where it will be held in place by the stake retention mechanism 146 until it is driven into the soil. The stake retention mechanism may be a magnet, a tension spring, or any appropriate mechanical means for capturing and holding a stake in a position and orientation to be driven into the soil to hold the drip tape in place. It should be noted that the stake guide discussed in this paragraph has been removed from FIG. 2 to show the components inside the stake driver 140. However, examples of stake guides and operation are also described herein, including with reference to FIGS. 3A, 3B, and 3C.

The compressed air used to drive a pneumatic example of the linear actuator of FIG. 2 may be stored in a compressed air tank 150. The compressed air may be delivered from the compressed air tank 150 to a pressure regulator 160, and then to an activation control 165, by additional pneumatic tubes 155.

An operator may control the amount of force with which the stake driver 140 pushes a stake into the soil by adjusting the pressure using the pressure regulator 160. Once the air pressure is at an appropriate level, the operator can use the activation control to extend or retract the linear actuator 142.

As previously mentioned, the drive system powering the linear actuator 142 may be compressed air (e.g. pneumatic drive). In other examples, the drive system may be an electric drive, a hydraulic drive, or human power.

In some examples of drip tape installation tools, the activation control 165 may be a solenoid switch which controls how the compressed air in a pneumatic system is routed to the linear actuator 142. In other examples, the solenoid switch may be replaced and/or augmented by an automated control such as a microprocessor. The microprocessor may control the timing of the linear actuator 142, either in response to an operator command or to a condition sensed by the microprocessor, such as moving past a pre-defined distance from a previously placed stake. A location sensor, such as a GPS receiver or similar global navigation satellite system (GNSS) may be used to determine the distance from a previously placed stake.

FIGS. 3A, 3B, and 3C provide additional detail on the stake driver and its components. Although each figure will be discussed separately, it may be helpful to refer to all three figures simultaneously in the following paragraphs.

For the following discussion and throughout this specification, the term “stake” will generally be used to describe a general category of outdoor fasteners, which include but are not limited to landscaping staples, anchors, and spikes, or any type of fastener intended to be driven into soil for the purpose of holding a material such as irrigation drip tape or landscaping fabric in place. Although a U-shaped stake is shown in the figures herein, any appropriate shape stake may be used. A stake may be constructed from metal using bent-wire construction, or may be molded from plastic or any other appropriate material.

FIG. 3A is a perspective view of the stake driver of the drip tape installation tool of FIG. 1. A stake 300 is inserted into a stake guide 145. A purpose of the stake guide 145 may be to keep the stake 300 at the proper orientation as it slides down into the stake chute 147. The stake chute 147 is a channel designed to hold a stake 300 in place until the linear actuator extends 142, pushing the plunger 144 into the stake chute 147, pressing down on the stake 300 and driving it into the soil. The stake 300 is held in place by a stake retention mechanism 146, such as a magnet or tension spring mounted inside the stake chute 147.

FIG. 3B is a side view of the stake driver of FIG. 3A and is provided to show an alternate view of the stake driver for clarity. All components of FIG. 3B are present in FIG. 3A and have been described previously.

FIG. 3C is a perspective view of the stake guide component of the stake driver of FIG. 3A. In the embodiment of FIG. 3C, the stake guide 145 comprises a stake guide slide 310, down which a stake slides when placed there by an operator until the stake drops off the lower end of the stake guide slide 310 and falls into the stake chute 147 (FIGS. 3A and 3B) where it is held until driven into the soil.

FIGS. 4 and 5 provide examples of various types of drip tape guides. FIG. 4 shows an embodiment of a drip tape guide used for rotating a drip tape into an angle of rotation which matches the angle of rotation of the surface on which the tape will be installed (for example, the relatively flat surface of the ground to which the drip tape will be staked.) FIG. 5 shows an embodiment of a drip tape guide used for holding a drip tape in an optimal position for installation, once the drip tape has been rotated to the proper angle for installation.

FIG. 4 is a perspective view of one embodiment of a first drip tape guide for use on the drip tape installation tool of FIG. 1. In some examples, the first drip tape guide 130 has a drip tape entry 136, into which a length of drip tape is inserted. The drip tape then passes through a twist section 134 which twists the drip tape as is passes through until it matches the orientation of the drip tape exit 132.

The amount of rotation caused by the twist section 134 may be 90 degrees, allowing the flat drip tape to be rotated from an approximately vertical orientation to an approximately horizontal orientation that can be placed on the soil and staked in place. In some examples, the angle of rotation may vary, depending on the angle of the drip tape reel in relation to the angle of the surface to which the drip tape will be installed.

FIG. 5 is a perspective view of a second drip tape guide for use on the drip tape installation tool of FIG. 1. The second drip tape guide 135 has a flat main body with a drip tape feed slot 138 cut into it. The drip tape feed slot 138 may be sized to fit a particular width of drip tape with little additional space to allow for side-to-side movement of the drip tape. In some examples, the second drip tape guide 135 may be mounted on or beneath the stake driver and is used to hold a length of drip tape in position above the soil such that a stake driven down on top of the drip tape will hold the drip tape in place in the soil. In some examples, the second drip tape guide 135 may be built into a portion of the stake driver, such as the staple chute (FIG. 3A, 147), as opposed to being a completely separate component.

Although the embodiment shown in the figures in this application have two drip tape guides (130, 135), any appropriate number of drip tape guides may be used. As previously discussed, the first drip tape guide 130 of FIG. 4 may not be needed if the drip tape exits the drip tape roll already in the proper orientation for installation. Alternately, a series of three or more drip tape guides may be used to route the drip tape from the drip tape roll along the device to prepare it for placement and installation.

FIG. 6A shows a rear view of the stake driver of FIG. 3A as it is used in staking irrigation drip tape. FIG. 6A focuses on the stake driver itself and omits the other elements of the drip tape irrigation tool for clarity, such as the cart frame, drip tape reel, and pneumatic system.

FIG. 6A shows a length of drip tape 125 as it emerges from the second drip tape guide 135 mounted at the bottom of the stake driver. The drip tape 125 is held in place by previously placed stakes 300B, shown partially driven into soil (not shown). The drip tape guide 135 holds the drip tape 125 in position, centered beneath the emerging points 300A of the next stake to be placed.

A stake is placed by an operator into the stake guide 145 and allowed to drop into the stake chute 147. The stake is held inside the stake chute 147 (shown here as emerging stake points 300A) by a stake retention mechanism 146, previously described. Once the stake is in position in the stake chute 147, the linear actuator may be engaged to drive the stake into the soil, holding the drip take 125 in position.

FIG. 6B shows a side view of the stake driver of FIG. 3A as it is used in staking irrigation drip tape. This alternate view is provided to better detail the components of the stake driver system of FIG. 6A. This side view shows the linear actuator 142 and plunger in position above the stake chute 147, ready to drive the stake (shown as emerging stake points 300A) into the soil 330. All other elements are common to FIG. 6A and have been previously explained with that figure.

FIG. 7 is a flowchart detailing the steps of a method for installing irrigation drip tape, proceeding from Start block 700 down through Finish block 750.

In Step 710, drip tape is fed into one or more drip tape guides, as described previously in this specification. A stake driver is then oriented over the drip tape (Step 720) being held by the drip tape guides. The operator feeds a stake into the stake driver (Step 730) and then the stake driver is actuated when the stake driver is at a location appropriate for driving the stake into the soil to hold the drip tape. Steps 730 and 740 are repeated as necessary to place additional stakes over the drip tape.

### Alternate Embodiments and Examples

The examples and figures provided herein focus on an apparatus and method for the installation and securing of irrigation drip tape. However, in an alternate embodiment, the invention may be used for the installation and securing of agricultural material in general. In some examples, the agricultural material may be irrigation drip tape or drip tubing. In other examples, the agricultural material may be landscaping fabric. In still other examples, the agricultural material may be erosion control netting or mesh.

In these examples, the agricultural material may be dispensed onto the ground by an agricultural material dispenser, which may be a roll of agricultural material mounted on the cart frame such that it rotates freely, allowing the agricultural material to be drawn off of the roll and distributed in an appropriate manner on the ground. Once the material is distributed, a stake driver may stake the material in place on the ground as previously described herein.

From the foregoing it will be appreciated that, although specific embodiments of the invention have been described herein for purposes of illustration, various modifications may be made without deviating from the spirit and scope of the invention.

What is claimed is:

1. An apparatus for installing irrigation drip tape, comprising:
a wheeled frame;
a reel mounted on the wheeled frame and configured to hold a roll of irrigation drip tape, the roll of irrigation drip tape able to rotate freely on the reel;
a stake driver, the stake driver configured to drive an agricultural stake into a soil;
an activation control, the activation control configured to cause the stake driver to drive the agricultural stake into the soil; and
a drip tape guide mounted on the wheeled frame, the drip tape guide configured to position irrigation drip tape dispensed from the reel under the stake driver such that the agricultural stake holds the irrigation drip tape in position when driven into the soil responsive to the activation control.

2. The apparatus of claim 1, wherein the stake driver comprises a linear actuator and a drive system, the drive system providing energy to the linear actuator to extend and retract to drive the agricultural stake into the soil.

3. The apparatus of claim 2, wherein the drive system is a pneumatic system.

4. The apparatus of claim 2, wherein the drive system is an electric drive.

5. The apparatus of claim 2, wherein the drive system is human power.

6. The apparatus of claim 1, wherein the activation control comprises a microprocessor configured to automatically actuate the stake driver.

7. The apparatus of claim 1, wherein the activation control comprises a user interface configured to receive input, the input indicative of when the stake driver should drive the agricultural stake into the soil.

8. The apparatus of claim 1, further comprising a second drip tape guide, the second drip tape guide configured to turn the irrigation drip tape to a first angle for installation that is different than a second angle at which the irrigation drip tape exits the roll of irrigation drip tape.

9. An apparatus for placement of an agricultural material in soil, the apparatus comprising:
a linear actuator;
a plunger, the plunger attached to the linear actuator and configured to push against a top side of an agricultural stake;
a stake chute configured to guide movement of the agricultural stake in a direction and at an orientation;
a drive system for the linear actuator, the drive system providing energy to the linear actuator to extend and retract to drive the agricultural stake into the soil; and
an activation control, the activation control configured to cause the linear actuator to drive the agricultural stake into the soil.

10. The apparatus of claim 9, wherein the stake chute includes a magnet, the magnet configured to hold the agricultural stake in a position and at an orientation to be driven into the soil.

11. The apparatus of claim 9, wherein the stake chute includes a tension spring, the tension spring configured to hold the agricultural stake in a position and at an orientation to be driven into the soil.

12. The apparatus of claim 9, wherein the drive system is a pneumatic system.

13. The apparatus of claim 9, wherein the drive system is an electric drive.

14. The apparatus of claim 9, wherein the drive system is human power.

15. The apparatus of claim 9, wherein the apparatus further comprises an agricultural material dispenser, the agricultural material dispenser configured to feed the agricultural material onto the soil such that the agricultural stake will pin it in place on the soil.

16. The apparatus of claim 15, wherein the agricultural material is irrigation drip tape.

17. The apparatus of claim 16, wherein the agricultural material is landscaping fabric.

18. The apparatus of claim 9, wherein the activation control comprises a microprocessor configured to automatically determine when the linear actuator should drive the agricultural stake into the soil.

19. The apparatus of claim 9, wherein the activation control is a user control configured to receive input indicative of when the linear actuator should drive the agricultural stake into the soil.

20. A method for installing irrigation drip tape, the method comprising:
feeding a length of irrigation drip tape into a drip tape guide, the drip tape guide configured to lay the irrigation drip tape at a position and at an orientation onto an area of soil;
orienting a stake driver configured to drive agricultural stakes into soil such that the agricultural stakes are placed to hold the irrigation drip tape at the position and at the orientation in the area of soil;
supplying one or more agricultural stakes to the stake driver; and
actuating the stake driver to drive the agricultural stakes into the area of soil at desired intervals.

21. The method of claim 20, further comprising using a pneumatic system to drive the stake driver.

22. The method of claim 20, further comprising using an electric drive to drive the stake driver.

23. The method of claim 20, further comprising supplying human power to drive the stake driver.

24. The method of claim 20, wherein the length of irrigation drip tape is taken from a roll of irrigation drip tape, and the roll of irrigation drip tape, the drip tape guide, and the stake driver are mounted on a wheeled structural frame which can be guided through a field by a human operator.
